(19) United States
(12) Patent Application Publication
(10) Pub. No.: US 2020/0065582 A1
(43) Pub. Date: Feb. 27, 2020

(54) ACTIVE HYPERSPECTRAL IMAGING WITH A LASER ILLUMINATOR AND WITHOUT DISPERSION

(71) Applicant: BATTELLE MEMORIAL INSTITUTE, Columbus, OH (US)

(72) Inventors: Andrew P. Bartko, Worthington, OH (US); Theodore J. Ronningen, Lewis Center, OH (US); Jared Schuetter, Columbus, OH (US)

(21) Appl. No.: 16/545,846

(22) Filed: Aug. 20, 2019

Related U.S. Application Data
(60) Provisional application No. 62/720,360, filed on Aug. 21, 2018.

(51) Int. Cl. G06K 9/00; G01J 3/28; G01J 3/40; G01J 3/10; G01N 21/31; G06K 9/20; G06K 9/62; H04N 5/232

(52) U.S. Cl. CPC G06K 9/00624; G01J 3/2823; G01J 3/40; G01J 3/10; G01N 21/3151; G01N 2201/129; G06K 9/6202; H04N 5/232; G01J 2003/2826; G01J 2003/102; G01N 2201/0612; G06K 9/2027

(57) ABSTRACT

Hyperspectral imaging is carried out by utilizing a set of lasers to illuminate a scene containing a sample in a series of successive laser illuminations by turning on at least one laser in the set of lasers for each successive illumination in the series. Here, each laser generates a known wavelength of light. Imaging is further carried out by utilizing a camera to capture an image of the scene during each successive laser illumination, thus generating a series of successive images. However, no dispersive element is utilized between the scene and the camera. Imaging is still further carried out by processing the captured images to produce scene data. The scene data is compared with target profiles to determine whether the scene includes at least one target of interest and taking a predetermined action in response to detecting at least one target of interest.

### CROSS REFERENCE TO RELATED APPLICATIONS

This application claims the benefit of U.S. Provisional Patent Application Ser. No. 62/720,360, filed Aug. 21, 2018, entitled ACTIVE HYPERSPECTRAL IMAGING WITH A LASER ILLUMINATOR AND WITHOUT DISPERSION, the disclosure of which is hereby incorporated by referenced.

### BACKGROUND

Various aspects of the present disclosure relate generally to imaging, and in particular to active hyperspectral imaging using a set of lasers to illuminate a scene.

Hyperspectral imaging is a technique that can be employed to collect and process spectral information from across the electromagnetic spectrum. In typical applications, multiple scans of a sample area are combined into a “hyperspectral cube”, which represents the collected data in three dimensions, (x, y, λ). That is, collected data combines both spatial information (x and y) and spectral information (λ). Because a spectrum is collected at each pixel point of data, no prior knowledge of the sample under evaluation is required. Rather, all analysis can be carried out based upon the generated hyperspectral cube. However, hyperspectral imaging systems are currently relatively expensive due in large part to the cost and complexity of necessary detectors, complexity of required processing, and large data storage capacity required to generate and store hyperspectral cubes.

### BRIEF SUMMARY

According to aspects of the present disclosure, a hyperspectral imaging system comprises narrow-band lasers, a spectrograph, a camera coupled to the spectrograph, and an analyzer coupled to lasers and the camera. The narrow-band lasers are provided for illumination of a scene that comprises a collected sample. In this regard, the narrow-band lasers have different operating wavelengths, where each operating wavelength corresponds to a respective target wavelength for an object of interest suspected of being in the sample within the scene. The spectrograph collects light reflected from the scene without dispersive optical elements interposed between the imaging spectrograph and the scene, and the camera captures images of the light collected by the spectrograph. In operation, the analyzer performs a series of illuminations of the scene by selecting and controlling at least one narrow-band laser for each successive illumination. The analyzer also controls the camera to capture an image of the scene for each successive illumination, thus generating a series of images. The analyzer further processes the images to produce scene data, compares the scene data with a known target profile to determine whether the sample includes the object of interest, and takes a predetermined action in response to detecting the object of interest.

According to further aspects of the present invention, a process of performing hyperspectral imaging of a scene is provided. The process comprises successively illuminating the scene with at least one laser selected from a set of lasers, the lasers in the set of lasers having different operating wavelengths, where each operating wavelength corresponds to a respective target wavelength for an object of interest suspected of being in a sample within the scene. The process also comprises capturing an image of the scene with a camera during each successive illumination, thus generating a series of successive images. Each image is captured without dispersive elements being interposed between the scene and the camera. The process yet further comprises processing the successive images to produce scene data and comparing the scene data with a target profile. Moreover, the process comprises determining, in response to comparing the scene data with the target profile, whether the collected sample includes the object of interest, and taking a predetermined action in response to determining that the collected sample includes the object of interest.

### BRIEF DESCRIPTION OF THE SEVERAL VIEWS OF THE DRAWINGS

FIG. 1 is a schematic of a hyperspectral imaging system according to aspects of the present disclosure;

FIG. 2 is a block diagram of a hyperspectral imaging system according to aspects of the present disclosure;

FIG. 3 is a flowchart of a process of performing hyperspectral imaging according to aspects of the present disclosure;

FIG. 4 is a chart illustrating sample data showing wavelength data collected from lasers in the set of lasers; and

FIG. 5 is a chart illustrating sample data showing wavelength data collected from lasers in the set of lasers.

### DETAILED DESCRIPTION

Spectral imaging is a non-contact (remote sensing) approach for collecting information from a sample area (i.e., scene). Basically, detection, classification, quantification, combinations thereof, etc., of an object in a scene, can be carried out based upon detected differences in spectral reflectance over select regions of the electromagnetic spectrum. Hyperspectral imagers, e.g., as disclosed herein, capture image data that is spectrally resolved at each spatial point in the scene. For instance, in example embodiments, the spectral range is generally across the near-infrared and the visible spectra. Moreover, the spectral resolution can be on the order of 10 nanometers (nm) or less, thus distinguishing a hyperspectral imager from a multispectral imager (which typically measures significantly less bands, each band covering a wider spectrum). In view of the above, and according to aspects herein, hyperspectral imaging processes and systems are disclosed.

Typical hyperspectral imagers employ a light dispersion technology to separate the spectral data before light reaches the sensor. The sensor is typically a two-dimensional array where one dimension of the array is used to record the spectrally dispersed light whereas the other dimension of the array is used to record a spatial map. In this arrangement, only one spatial slice of the image is recorded per exposure, so multiple exposures are required to capture a scene and assemble a three dimensional ‘hypercube’ of spectral and spatial data.

Comparatively, according to aspects herein, hyperspectral imaging is carried out by collecting multiple images of a scene, where each image contains spatial data in two dimensions (x₁ . . . xₘₐₓ, y₁ . . . yₘₐₓ), and spectral data (λ) across a single (or very narrow) waveband, such as 10 nm or less. In some embodiments, each image is collected so as to cover the same spatial area (x₁ . . . xₘₐₓ, y₁ . . . yₘₐₓ), but different waveband (λᵢ) or narrow waveband. For instance, at least one of the lasers in a set of lasers is turned on, and then off, in a series of successive laser illuminations. In this regard, each successive illumination generates a distinct wavelength λi (or wavelengths) of light. A camera captures a record of the scene (e.g., a two-dimensional image) during each successive laser illumination, and the successive, collected images are combined to form a hyperspectral data cube that represents three-dimensional data, (x, y, λ).

Aspects herein improve the technology of hyperspectral imaging systems by eliminating the need for expensive, heavy, optically complex components, such as dispersive elements and tunable filters, e.g., which are typically required to be interposed between the imaging spectrograph and the scene to separate, filter, or otherwise manipulate spectral information in light reflected from a scene.

Rather, simple optics are enabled through the use of a set of lasers. The lasers have different operating wavelengths, where each operating wavelength corresponds to a respective target wavelength for an object of interest suspected of being in a sample under evaluation. Since the lasers themselves are spectrally resolved, hyperspectral imaging systems herein collect light reflected from the scene without dispersive optical elements interposed between the imaging spectrograph and the scene. Moreover, the incorporation of a limited set of lasers herein reduce the size of a resulting hypercube since the spectral dimension of the hypercube is constrained to spectral ranges of the lasers. For instance, illumination wavelengths known to capture information about an object of interest can be selectively used more often, providing more rapid data about that object. As a result, data collection is faster than conventional approaches, subsequent analysis is simplified, and cost and complexity are greatly reduced.

Further aspects herein improve the technology of hyperspectral imaging systems by simplifying the requirements on the imaging sensor. For instance, the illumination sources herein enable relatively large amounts of light, e.g., greater than conventional sources (LED, incandescent, etc.), which allows relatively shorter exposure times. This translates into faster processing, more data capture, or a combination thereof, compared to conventional systems.

Other advantages will become apparent and are described more fully herein.

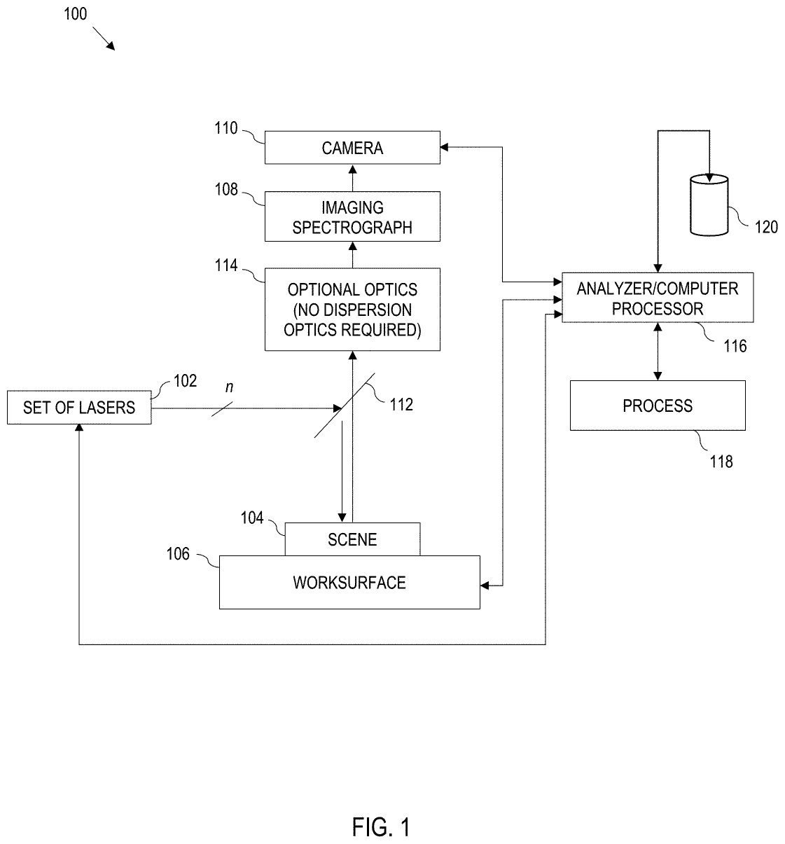

Referring now to the drawings, and in particular to FIG. 1, a hyperspectral imaging system 100 is illustrated. The hyperspectral imaging system 100 comprises a set of lasers 102. As will be described in greater detail herein, the set of lasers 102 comprises any number, e.g., n lasers where n is any positive integer. For instance, some embodiments include a minimum of two lasers. In other embodiments, the set of lasers 102 includes multiple lasers, (e.g., more than two lasers), the number of which is dependent upon the desired resolution and/or object(s) of interest. In this regard, applications that require the detection of different objects of interest, or require several wavebands of data for proper classification of object(s) of interest, will require more than two lasers, e.g., some embodiments may use 3-6 lasers, other embodiments may use 7-10 lasers, and in some cases, some embodiments may utilize more than 10 lasers.

Regardless of the total number of lasers, the lasers in the set of lasers 102 are selectively controlled to direct one or more beams at a time, in succession for illumination of a scene 104. For some embodiments, the set of lasers 102 illuminate the scene 104 without dispersive elements being interposed between the set of lasers 102 and the scene 104. Moreover, in certain embodiments, each laser (in the set of lasers 102) has a known wavelength and spectrally narrow output, defining a set of narrow-band lasers. In further example embodiments, lasers in the set of lasers 102 have different known operating wavelengths, bandwidths, or combinations thereof. For instance, each laser can have a pre-selected (and optionally different/unique), operating wavelength based upon the wavebands of interest for a particular implementation, e.g., where each operating wavelength corresponds to a respective target wavelength for an object of interest suspected of being in a sample within a scene. Other laser configurations can alternatively be utilized, examples of which are described with regard to any one or more of the FIGURES herein.

The scene 104 comprises a collected sample and may be supported on an optional worksurface 106, e.g., positioning stage, tape roll, sample slide, or other suitable support structure. Moreover, the worksurface 106 can be fixed or controllable, e.g., to advance, index, move, etc., a sample within the scene 104 into an interrogation region that is in an optical path of the set of lasers 102. In this regard, the form factor of the worksurface 106 can vary depending upon the type of analysis being carried out.

Laser light that is directed toward the scene 104 is reflected therefrom, toward an imaging spectrograph 108 that collects light responsive to illuminations of the scene 104. In embodiments herein, the imaging spectrograph 108 collects reflected light from the scene 104 without dispersive optical elements interposed between the imaging spectrograph 108 and the scene 104.

A camera 110 is operatively coupled to the imaging spectrograph 108. In this configuration, the output of the imaging spectrograph 108 is captured as a record (e.g., image file) by the camera 110. For instance, in example embodiments, the camera 110 has a camera sensor that is read out during each successive illumination of the scene 104 to generate images from an output of the imaging spectrograph 108. Accordingly, each collected record (image) represents spatial data collected in two dimensions, and spectral data corresponding to the wavelength of the laser selected from the set of lasers 102 for the associated illumination.

The hyperspectral imaging system 100 may include any necessary optics, e.g., an optional beam splitter 112, and/or additional optional optics 114 in a first optical path between the set of lasers 102 and scene 104 and/or in a second optical path between the scene 104 and the camera 110. Other examples of the additional optics 114 can include optical devices such as an objective, collimating lens, focusing optics, etc. However, unlike typical hyperspectral imaging systems, the hyperspectral imaging system 100 does not require dispersion optics, including a tunable filter or collection of movable filters, in either the first optical path or second optical path, to create the spectrally resolved dimension of the data in a generated hypercube.

The lack of dispersion optics changes the principle of operation of the illustrated hyperspectral imaging system 100 considerably compared to conventional hyperspectral imaging systems. For instance, conventional systems typically use a dispersive optic in front of an image sensor. As such, each two-dimensional image includes a spatial dimension and a spectral dimension. Comparatively, the hyperspectral imaging system 100 uses the camera 110 to capture images in two dimensions that include a first spatial dimension and a second spatial dimension.

As illustrated, an analyzer 116 is operatively coupled to the (narrow band) lasers in the set of lasers 102 and the camera 110. In some embodiments, the analyzer 116 can also be coupled to other components, such as the work surface 106, the imaging spectrograph 108, combinations thereof, etc. The analyzer 116 can comprise any processor, controller, computer hardware, and executable program code necessary to operate the hyperspectral imaging system 100. In this regard, the analyzer 116 can control the set of lasers 102, the work surface 106, the imaging spectrograph 116, the camera 110, combinations thereof etc., to build a hypercube, analyze the collected data, and take any necessary actions, e.g., by triggering alarms, stopping workflows, interacting with another process 118 to control the process 118 based upon an analysis, etc. Moreover, although schematically illustrated as a single analyzer 116, in practice, the logical functions of the analyzer 116 can be divided into more than one device, e.g., a controller and a data analysis processor, etc.

In an example embodiment, the analyzer 116 controls the set of lasers 102 to illuminate the scene 104 (containing a sample) in a series of successive laser illuminations by turning on at least one laser in the set of lasers for each successive illumination in the series. Between successive illuminations, the lasers can be turned off. More specifically, the analyzer 116 dictates a series of successive laser illuminations by repeatedly selecting and controlling a selected laser (or lasers) of the set of lasers 102 to turn on to illuminate the scene 104, then turn off. By turning selected lasers in the set of lasers 102 on and off in a sequential series, e.g., such that only one laser (or group of lasers) illuminates the scene 104 at any given time), the camera 110 can capture corresponding spectrally resolved images.

For instance, in some embodiments, one narrow-band laser is illuminated at each illumination. In alternative embodiments, at least two narrow-band lasers are illuminated for each successive illumination. In yet further embodiments, each illumination can utilize the same or different number of lasers.

The analyzer 116 correspondingly controls the camera 110 to capture an image (or images) of the scene 104 during each successive laser illumination, thus generating a series of successive images. In the illustrated embodiment, each image is spectrally resolved based upon the illumination wavelength (λ) and includes spatial information in at least two dimensions (x, y). In practical applications, the analyzer 116 controls the camera 110 to capture the full scene in each successive image. In other embodiments, only a part of the scene may be captured by one or more images.

In an example embodiment, the analyzer 116 processes the captured images to produce scene data (e.g., by generating a hypercube). Here, the analyzer 116 can select the lasers in the set of lasers 102 to cause the sequence of illuminations to occur in a predetermined pattern of laser wavelengths, where the pattern is selected based upon the available wavelengths among the lasers, and a desired profile of an object of interest. Here, the profile is configured/tailored or otherwise adapted to correspond to the available wavebands of the lasers in the set of lasers 102.

The analyzer 116 also compares the scene data with target profile(s) (e.g., stored in a data source 120) to determine whether the sample within the scene 104 includes at least one object of interest. Here, the analyzer 116 takes a predetermined action in response to determining that at least one object of interest is identified in the scene data, as set out more fully herein. In some embodiments, the data source 120 can store additional optional information, e.g., calibration data, control data, configuration data, target profiles and other relevant target data, the generated hypercube or other scene data, the captured images, etc.

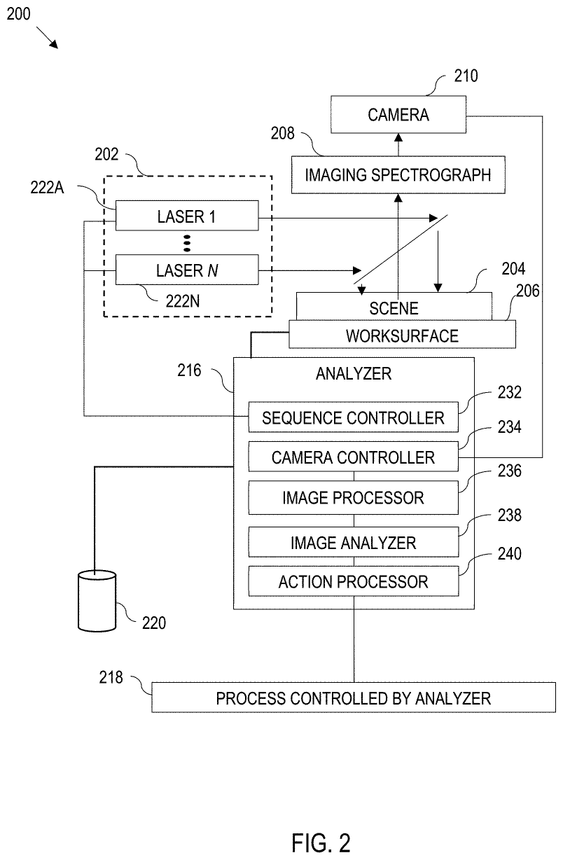

Referring to FIG. 2, a spectral imaging system 200 is illustrated. The spectral imaging system 200 includes analogous features to the spectral imaging system 100 of FIG. 1. As such, all features described with regard to FIG. 1 are incorporated into FIG. 2 unless specifically contradicted. Likewise, any features described with reference to FIG. 2 can be incorporated into the device and corresponding processes of FIG. 1, unless expressly contradicted. Moreover, like elements are illustrated with like reference numerals 100 higher than the counterpart in FIG. 1.

The hyperspectral imaging system 200 comprises a set of lasers 202. In an example embodiment, each laser in the set of lasers 202 has a known wavelength and spectrally narrow output, where lasers in the set of lasers have different known wavelengths. In some embodiments, each laser has a unique and different wavelength compared to the other lasers in the set of lasers 202.

As illustrated, the set of lasers 202 is comprised of a plurality of individual laser 222A . . . 222N (e.g., where N is analogous to n of FIG. 1). In practical applications, there can be as many as 6 or more different laser wavebands utilized, e.g., (for a general sensing application) but it is also possible to use less than 6 for specific sensing applications. In this regard, the number of discrete laser wavebands can be determined based upon the specific analysis being conducted. For instance, in a first example embodiment, there are two lasers. In a second example embodiment, there are 3-6 lasers. In a third example embodiment, there are 7-10 lasers. In a fourth embodiment, there are over 10 lasers.

In an example implementation, the set of lasers 202 are organized into respective channels. For instance, in an example embodiment, the set of lasers 202 comprises a series of fixed laser channels, (e.g., each channel is at a different spectral wavelength and/or wavelength distribution) that are specifically determined (e.g., a priori) based on knowledge of a known and finite group of objects of interest, e.g., one or more chemicals. That is, each laser 222A . . . 222N is preconfigured or otherwise selected to correspond to a specific wavelength and narrow spectral range that is indicative of the presence of at least one of the objects of interest. In this regard, a “channel” refers to a wavelength (and/or narrow wavelength distribution). Thus, the set of lasers 202 can be organized into channels where each channel comprises at least one laser of the set of lasers 202, and each channel is at a different and known spectral wavelength/wavelength distribution compared to the remaining channels.

In an example embodiment, the lasers 222A . . . 222N in the set of lasers 202 comprise one or more diode lasers. Diode lasers are small, lightweight, and can be made to be robust for use in a wide range of environments. Further, diode lasers have a natural spectral width that is low enough for many practical applications, e.g., about 10 nanometers (nm). Moreover, diode lasers can also be spectrally narrowed if required by a specific application. Yet further, diode lasers produce sufficient power to illuminate an outdoor scene and overwhelm any natural light that may be present.

Analogous to the hyperspectral imaging system 100 of FIG. 1, the hyperspectral imaging system 200 of FIG. 2 includes a scene 204 upon which a sample has been collected, deposited, located, or otherwise identified (e.g., on a worksurface 206). In practical applications involving chemical analysis, the sample is collected onto a sample substrate, which is positioned or otherwise located in an area corresponding to the scene 204. The sample may comprise, for instance, a chemical sample that is suspected of containing a target chemical (or target chemicals) of interest.

Light from the scene 204 is directed to an imaging spectrograph 208 that collects light responsive to illuminations from lasers in the set of lasers 202. The output of the imaging spectrograph 208 is coupled to a camera 210. The camera 210 includes a camera sensor that generates images from the output of the imaging spectrograph by capturing image data in two dimensions. For instance, the camera 210 can include a charge-coupled device array that captures spatial data in two dimensions. Spectral data is determined based upon the wavelength of the laser(s) illuminating the scene 204 when an image is captured. In this regard, the image sensor should be sensitive to the range of light reflected in response to illumination by each laser in the set of lasers 202.

Optionally, the hyperspectral imaging system 200 can include optics in an optical path between the scene 204 and the camera 210. However, any such optics between the scene 204 and the camera 210 do not include a dispersive element, e.g., a dispersion optic, a tunable filter, set of moving filters, etc., in order to define the spectral resolution of a captured image.

Also analogous to that of FIG. 1, an analyzer 216 controls components of the hyperspectral imaging system 200, and evaluates the results collected by the camera 210. Based upon the results, the analyzer 216 can control a process 218, examples of which are described more fully herein.

In an example embodiment, the analyzer 216 controls the set of lasers 202 to illuminate the scene 204, which contains a sample of interest. The analyzer 216 controls the set of lasers 202 to emit a series of successive laser illuminations by turning on at least one laser in the set of lasers 202 for each successive illumination in the series. The analyzer 216 can optionally control the set of lasers 202 to turn off the lasers selected for illumination once an image has be captured by the camera 210. In this manner, the analyzer 216 also controls the camera 210 to capture an image of the scene 204 during each successive laser illumination, thus generating a series of successive images.

In a manner analogous to that of FIG. 1, the analyzer 216 further processes the captured images to produce scene data and compares the scene data with target profiles to determine whether the scene includes at least one object of interest (e.g., chemical selected from a target chemical list). Yet further, the analyzer 216 takes a predetermined action in response to detecting at least one object of interest, examples of which are set out in greater detail herein.

As illustrated, the analyzer 216 is communicably coupled to the set of lasers 202 (e.g., via a suitable laser controller), optionally to the worksurface 206, to the camera 210, and optionally, to any process 218 as the specific implementation dictates. In this regard, the analyzer 216 is schematically illustrated as including a sequence controller 232, a camera controller 234, an image processor 236, an image analyzer 238, and an action processor 240. The analyzer 216 carries out a sample analysis operation by coordinating the sequence controller 232 and the camera controller 234 in a first phase (data collection phase) of the sample analysis operation to collect sample data. The analyzer 216 controls the image processor 236 in an analysis phase of the sample analysis, to prepare the collected data for subsequent data analysis. Moreover, the analyzer 216 controls the image analyzer 238 to analyze the sample on the scene. Based upon the decision reached by the image analyzer 238, the analyzer 216 may optionally utilize the action processor 240 to control an associated process 218, e.g., in an action phase of the sample analysis.

The sequence controller 232 controls the set of lasers during the data collection phase of the sample analysis operation. More particularly, once a sample is loaded, moved, translated, deposited, collected, or otherwise presented in an area corresponding to the scene 204, a sample analysis operation can be carried out. The analyzer 216 utilizes the sequence controller 232 to control the lasers in the set of lasers 202 to sequentially illuminate the sample at the sample scene. In example applications, the sequence controller 232 controls the set of lasers 202 such that only one laser 222A . . . 222N in the set of lasers 202 illuminates at a time for each illumination in the series of successive laser illuminations. In other applications, two or more lasers 222A . . . 222N in the set of lasers 202 can be controlled by the sequence controller 232 to illuminate in a single illumination instance of the series of successive laser illuminations. In other embodiments, each illumination can take advantage of any number of the lasers in the set of lasers. Where channels are utilized by the laser system, the analyzer 216 controls the set of lasers such that only one channel is selected for laser illumination at a time.

The analyzer 216 controls the sequence/timing/duration of illumination of the selected lasers, based upon the object(s) of interest. For example, in a chemical application, the hyperspectral imaging system can be configured to detect one or more different chemicals of interest. In this regard, each chemical of interest has a known profile having indicators that are indicative of the presence of the object. As such, the analyzer 216 matches up the selection of lasers in the set of lasers 202 having wavelengths/narrow wavebands that correspond with known indicators of the objects.

Moreover, the analyzer 216 selects the necessary lasers in the set of lasers 202, sets the laser order/sequence, and controls the timing of illumination based upon the profiles of targets of interest. Thus, not every laser in the set of lasers 202 need by used in a particular sequence. Rather, the set of lasers 202 define the available wavelengths/narrow wavebands that can be selected from for specific evaluations.

In some embodiments, the analyzer 216 causes the selected laser (or lasers) in the set of lasers 202 to illuminate the entire scene in a single illumination. In other embodiments, the laser(s) can be caused to scan the scene (e.g., illuminate in a point, line, area, etc.) before switching lasers. As such, the system may collect multiple images before switching lasers.

The camera controller 234 coordinates with the sequence controller 232 to control the camera 210 to capture a series of images corresponding to the sequence of illuminations. In this regard, the analyzer 216 tags each image in the series of images to a corresponding illumination in the sequence of illuminations triggered by the sequence controller 232. As noted above, depending upon the application, the sequence controller 232 may select a single laser channel/single laser for an single illumination. In some embodiments, the sequence controller 232 may cause multiple lasers (or multiple laser channels—e.g., a pair of laser channels) to illuminate at one or more steps in a sequence. As such, the camera controller 234 correspondingly captures one channel per camera image, or multiple channels per camera image (e.g., a pair of channels for one or more select camera images), where the selected channel (or channels) define the spectral resolution of the captured image.

The image processor 236 is optional but can be useful to provide any necessary image processing prior to analysis. As noted more fully herein, spectrally resolved data is obtained by selecting a specific laser 222A . . . 222N in the set of lasers 202 to illuminate on during each camera image capture event, e.g., camera sensor readout. Each laser 222A . . . 222N produces a known wavelength and thus a spectrally narrow output. Therefore, the reflected laser light reaching the sensor of the camera is known to be at that wavelength (or wavelengths where multiple laser channels are utilized for a given camera image). Thus, image processing can comprise cropping, interpolating missing or erroneous pixels, filtering or enhancing, e.g., based upon known wavelengths/narrow spectral bandwidths of the selected channel (or channels) for a given image, normalizing, stitching (e.g., where multiple images are collected per illumination), etc. Moreover, since the spectral data can vary across images, the image processing techniques and/or parameters can vary across images in the series of images.

The image processor 236 can also assemble the series of images into a three-dimensional hypercube, which can be used for subsequent analysis. For instance, a hypercube of spectral and spatial data can be formed, where each captured image comprises spatial data in two dimensions and spectral data corresponding to the associated illumination.

The image analyzer 238 compares the output of the image processor 236 against one or more criteria to determine whether a sample within the scene 204 contains a target of interest, e.g., a chemical target of interest. In an example implementation, the collected data, (e.g., the hypercube, one or more images from the series of images, any collected metadata, combinations thereof, etc.) is analyzed against a database of known targets. For instance, target chemicals of interest can be identified in a data source 220 (analogous to data source 120 of FIG. 1), where each target chemical includes indicators, e.g., via a signature, map, or other specific data that maps the properties of the target chemical(s) to data corresponding to the available wavelengths/narrow wavebands of the lasers 222A . . . 222N in the set of lasers 202.

In performing the analysis, the image analyzer 238 can look for a collected data value (e.g., in the hypercube) that exceeds a predetermined threshold, look for a set of two or more data values that each exceeds a corresponding threshold, etc. Moreover, an identification can be based upon a probability or confidence factor, e.g., based upon a determination of how closely the measurements correlate to a corresponding signature, etc.

As an illustrative example, a chemical target list of chemicals of interest can be used in the design of a hyperspectral imaging system to select, e.g., a priori, the different spectral wavelengths and/or wavelength distributions necessary (e.g., necessary unique spectral wavelengths) to distinguish the chemicals of interest in the target list, and hence define the lasers necessary to be included in the set of lasers 202. Here, the analyzer 216 can use the different spectral wavelengths/wavelength distributions to select the lasers in the set of lasers 202 to carry out the series of successive laser illuminations corresponding to a desired implementation.

The action processor 240 receives an output from the image analyzer 238 and can take any necessary actions based upon the analysis. For instance, if a target chemical of interest is detected, the action processor 240 can generate a printout, send an electronic message, output an indication (e.g., by triggering an alarm, light, or other indicia). The action processor may also be programmed to stop a process 218 (e.g., to stop a process that utilizes a chemical from which the sample was collected) or otherwise take a pre-programmed action to initiate a workflow.

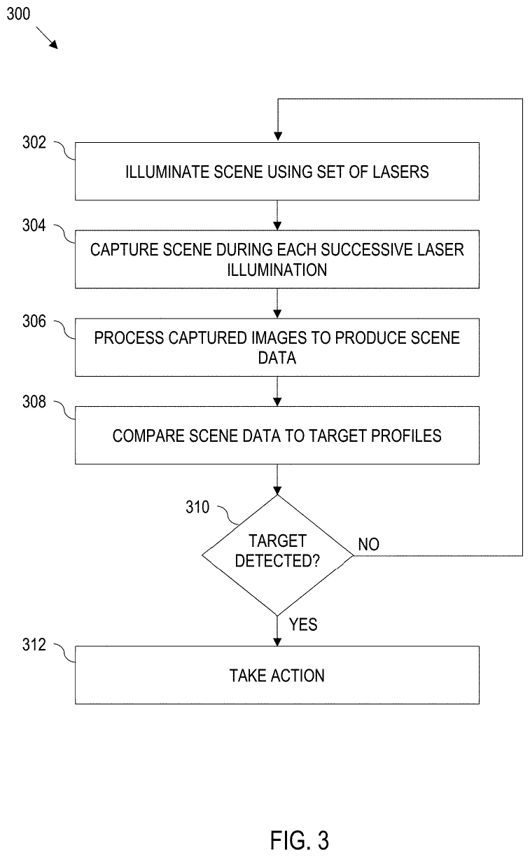

Referring to FIG. 3, a flowchart illustrates a process 300 of performing hyperspectral imaging according to aspects of the present disclosure. The process 300 can be carried out using any combination of the hyperspectral imaging system 100 (FIG. 1), the hyperspectral imaging system 200 (FIG. 2), or select components therebetween.

The process 300 comprises successively illuminating at 302, the scene with at least one laser selected from a set of lasers, each laser in the set of lasers generating a known spectral wavelength/wavelength distribution of light. For instance, as noted in greater detail herein, the process can illuminate at 302 the scene, by turning on at least one laser in the set of lasers for each successive illumination in a series of laser illuminations. Here, each laser can generate a known wavelength and/or narrow waveband of light.

In an example embodiment, the process 300 comprises controlling individual lasers in the set of lasers such that one laser is illuminated at a time for each illumination in the series of successive laser illuminations. In yet another alternative implementation, the process 300 may comprise controlling individual lasers in the set of lasers such that for at least one illumination in the series of successive laser illuminations, at least two lasers are illuminated.

In some embodiments, utilizing a set of lasers may comprise selecting a set of diode lasers to be used in the set of lasers, where each diode laser is selected to exhibit laser characteristics including a predetermined wavelength and narrow waveband of interest, corresponding to one or more targets of interest.

In some embodiments, the process further includes obtaining a chemical target list comprising chemicals of interest, using the chemical target list to identify and select necessary unique spectral wavelengths and/or wavelength distributions corresponding to the chemicals of interest, and using the selected unique spectral wavelengths and/or wavelength distributions to select the lasers to be utilized for the series of successive illuminations. Also (or alternatively), the available wavebands of the lasers can inform the targets that can be detected. That is, by knowing the available wavebands, a target list can be created or modified, that includes objects of interest that have a profile or signature that can be differentiated based upon the available wavebands.

The process 300 also comprises capturing at 304, an image of the scene with a camera during each successive illumination, thus generating a series of successive images, each image being captured without dispersive elements being interposed between the scene and the camera. In some embodiments, the full scene is recorded with each sensor read. In other embodiments, e.g., where scanning is required, the camera is controlled to record one or more images for an associated illumination, e.g., by capturing an image for each scan line, etc. For instance, the process 300 may comprise capturing each image with spatial information in two dimensions (x, y), and spectral information (λ), which corresponds to the unique known wavelength of light. That is, spectral data is captured based upon characteristics of the laser or lasers within the set of lasers used to illuminate the scene when the corresponding image is captured.

The process 300 further comprises processing, at 306, the captured successive images to produce scene data. For instance, in an example embodiment, the process 300 performs processing at 306 by combining the series of successive images to form a hypercube of spectral and spatial data, where each captured image comprises spatial data in two dimensions, (x, y) and spectral data (λ) corresponding to the associated illumination.

The process 300 yet further comprises comparing the scene data with the target profiles at 308 and determining at 310, whether the collected sample includes a target of interest. The determination can be carried out comparing the scene data with target profiles. For instance, in an example embodiment, the process 300 comprises processing, at 306, the captured images to produce scene data by building a hypercube and comparing at 308 the scene data with target profiles, by comparing the hypercube to data in the target profiles. Techniques to compare the generated hypercube to the target profiles is analogous to those techniques set out in greater detail herein, e.g., with reference to FIG. 1 and FIG. 2.

If no target is detected at 310, the process can continue, e.g., by collecting a new sample, analyzing a different region of the sample or scene, etc.

If a target is detected at 310, the process comprises taking, at 312, a predetermined action in response to determining that the collected sample includes the target of interest, i.e., that at least one target of interest is identified in the scene data.

In some embodiments, the predetermined action is carried out by performing actions in response to real-time analysis of the sample collected into the scene. As an additional example, in other embodiments, the predetermined action comprises interacting with an external device to stop a process that utilizes a chemical from which the sample was collected.

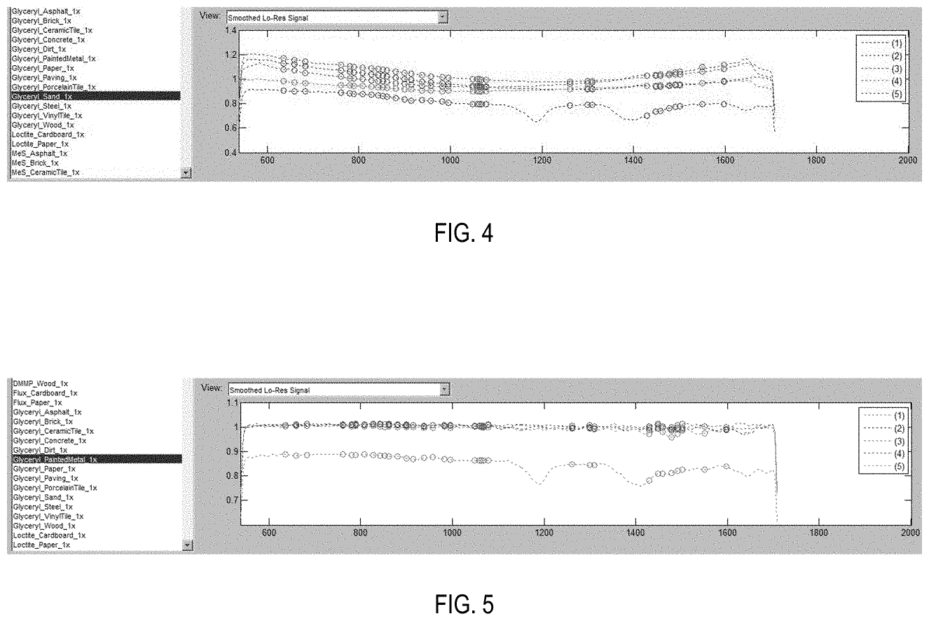

Referring to FIG. 4 and FIG. 5 generally, a set of available diode lasers was reviewed. The wavelength range these lasers span is the visible and near-infrared spectral regions, up to 1600 nm. The set of laser wavelengths available was compared against spectra collected with a commercial and conventional hyperspectral imaging system. As shown in FIG. 4 and FIG. 5, data could be collected at each of the circled wavelengths. Because the spectral features are broad, illumination of a scene at wavelengths of selected laser diodes was found sufficient to identify the presence or absence of targets of interest. Moreover, in practical applications, additional laser diodes can be added to the set of laser diodes to fill any identified specific wavelength gaps.

Aspects of the present disclosure bring about several technical advantages and solve several technical problems associated with conventional hyperspectral imaging systems. For instance, utilizing a set of lasers with different, known wavelengths, there is no need for dispersive optical elements, tunable filters or movable filters between the scene and a corresponding camera, thus eliminating weight complexity, size, expense, and improving reliability of the system. Correspondingly, the sensor can be simplified resulting in improved performance and decreased cost.

Also, in certain embodiments, the entire scene is being recorded with each sensor reading, thus allowing rapid changes in the scene can be captured. This is not possible in conventional systems because each reading comprises spectral data along a dimension, and spatial data along a second dimension. As such, the conventional imaging systems are required to scan, thus taking considerable time, and risking the opportunity of not capturing such rapid changes.

The amount of light available by using the laser illuminators herein, can be greater than from other illuminators (LED, incandescent, etc.), allowing for the sensor exposure time to be shorter, which allows more data to be captured.

In the present disclosure, if an object of interest is detected, the illumination wavelengths known to capture information about that object can be selectively used more often, providing more rapid data about that object.

In this regard, laser wavelengths can be selected in advance to optimize the chance of detecting specific targets.

The above features make aspects of the present disclosure particularly well suited for applications such as standoff hazard detection, security monitoring, chemical detection, etc.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. Aspects of the disclosure were chosen and described in order to best explain the principles of the disclosure and the practical application, and to enable others of ordinary skill in the art to understand the disclosure for various embodiments with various modifications as are suited to the particular use contemplated.

What is claimed is:

1. A hyperspectral imaging system comprising:
narrow-band lasers for illumination of a scene, the scene comprising a collected sample, the narrow-band laser having different operating wavelengths, each operating wavelength corresponding to a respective target wavelength for a object of interest suspected of being in the sample within the scene;
an imaging spectrograph that collects reflected light from the scene without dispersive optical elements interposed between the imaging spectrograph and the scene, the light being collected in response to the illumination of the scene;
a camera operatively coupled to the imaging spectrograph; and
an analyzer operatively coupled to the narrow-band lasers and the camera, wherein the analyzer:
controls successive illumination of the scene by selecting and controlling at least one narrow-band laser for each successive illumination;
controls the camera to capture an image of the scene for each successive illumination, thus generating a series of successive images;
processes the images to produce scene data;
compares the scene data with known target profiles to determine whether the sample includes the object of interest; and
takes a predetermined action in response to detecting the object of interest.

2. The hyperspectral imaging system of claim 1 further comprising:
an optical path between the scene and the camera, wherein the camera captures two dimensional spatial representations of the scene for each successive illumination; and
at least one non-dispersive optic in the optical path between the scene and the camera.

3. The hyperspectral imaging system of claim 1, wherein the analyzer controls the camera to capture a full scene in each successive image.

4. The hyperspectral imaging system of claim 1, wherein the narrow-band lasers are organized into respective channels, each channel having a different known spectral wavelength.

5. The hyperspectral imaging system of claim 1, wherein the narrow-band lasers comprise diode lasers.

6. The hyperspectral imaging system of claim 1, wherein the analyzer is further configured to:
obtain a chemical target list, the target list comprising chemicals of interest;
use the chemical target list, to identify and select necessary unique spectral wavelengths corresponding to the chemicals of interest; and
use the selected unique spectral wavelengths to identify lasers from the set of lasers for the successive illumination.

7. The hyperspectral imaging system of claim 1, wherein the predetermined action comprises stopping a process from which the sample was collected.

8. The hyperspectral imaging system of claim 1, wherein one narrow-band laser is illuminated at each illumination.

9. The hyperspectral imaging system of claim 1, wherein at least two narrow-band lasers are illuminated for each successive illumination.

10. The hyperspectral imaging system of claim 1, wherein the series of successive images form a hypercube having two-dimensional spatial data (x, y) and wavelength data (λ).

11. A process of performing hyperspectral imaging of a scene, the scene comprising a collected sample, the process comprising:
successively illuminating the scene with at least one laser selected from a set of lasers, the lasers in the set of lasers having different operating wavelengths, where each operating wavelength corresponds to a respective target wavelength for an object of interest suspected of being in a sample within the scene;
capturing an image of the scene with a camera during each successive illumination, thus generating a series of successive images, each image being captured without dispersive elements being interposed between the scene and the camera;
processing the successive images to produce scene data;
comparing the scene data with a target profile;
determining, in response to comparing the scene data with the target profile, whether the collected sample includes an object of interest; and
taking a predetermined action in response to determining that the collected sample includes the object of interest.

12. The process of claim 11, wherein capturing the image of the scene with the camera comprises:
capturing each image with spatial information in two dimensions (x, y) and spectral information (λ), wherein the spectral information corresponds to the unique known wavelength of light.

13. The process of claim 11 further comprising:
obtaining a chemical target list, the target list comprising chemicals of interest;
using the chemical target list to identify and select, necessary unique spectral wavelengths corresponding to the chemicals of interest; and
using the selected unique spectral wavelengths to select lasers from the set of lasers for the successive illumination.

14. The process of claim 11 further comprising illuminating one laser at a time.

15. The process of claim 11 further comprising illuminating at least two lasers at a time.

16. The process of claim 11, wherein processing the captured images comprises:
combining the successive images to form a hypercube of spectral data (λ) and spatial data (x, y).

17. The process of claim 11, further comprising:
building a hypercube; and
comparing the hypercube to data in the target profiles.

18. The process of claim 11, wherein successively illuminating the scene comprises:
selectively illuminating the scene with diode lasers, each diode laser having a corresponding predetermined wavelength and narrow waveband of interest, the predetermined wavelength corresponding to the target of interest.

19. The process of claim 11, wherein taking the predetermined action comprises performing actions in response to real-time analysis of the collected sample collected.

20. The process of claim 11, wherein taking the predetermined action comprises:
interacting with an external device to stop a process from which the sample was collected.
